(19) United States
(12) Patent Application Publication
(10) Pub. No.: US 2024/0144027 A1
(43) Pub. Date: May 2, 2024

(54) PERSONALIZED FEDERATED LEARNING OF GRADIENT BOOSTED TREES

(71) Applicant: International Business Machines Corporation, Armonk, NY (US)

(72) Inventors: Yuya Jeremy Ong, San Jose, CA (US); Yi Zhou, San Jose, CA (US); Parikshit Ram, Atlanta, GA (US); Theodoros Salonidis, Wayne, PA (US); Nathalie Baracaldo Angel, San Jose, CA (US)

(21) Appl. No.: 18/175,006

(22) Filed: Feb. 27, 2023

(30) Foreign Application Priority Data
Oct. 13, 2022 (GR) 20220100844

(51) Int. Cl. G06N 3/098

(52) U.S. Cl. CPC G06N 3/098

(57) ABSTRACT

A method, a computer program product, and a system of personalized training a machine learning model using federated learning with gradient boosted trees. The method includes training a global machine learning model using federated learning between a plurality of parties. The method also includes distributing the global machine learning model to each of the parties and receiving personalized model updates from each of the parties. The personalized model updates are generated from updated models boosted locally and produced by each of the parties using their respective local data. The method further includes fusing the personalized model updates to produce a boosted decision tree to update the global machine learning model. The method also includes training global machine learning model, iteratively, in this manner until a stopping criterion is achieved.

### BACKGROUND

The present disclosure relates to federated learning and, more specifically, using federated learning techniques to train personalized machine learning models.

Federated learning is a machine learning technique that trains algorithms across multiple decentralized edge devices or servers holding local data samples without exchanging the samples. The general principle of federated learning consists of training localized models on local data samples and exchanging parameters between local nodes to generate a global model shared by all nodes.

Gradient boosting is a machine learning technique that produces a prediction model in the form of an ensemble of weak prediction models, typically in the form of decision trees. A gradient boosted tree is a scalable implementation of the gradient boosting framework that combines a linear model with a boosting tree model. It can use a first derivative and the second derivative of a loss function for second-order derivation. This allows the algorithm to converge faster than a typical gradient boosting algorithm while also improving the efficiency of the optimal solution of the model.

### SUMMARY

Embodiments of the present disclosure include a computer-implemented method of personalized training of a machine learning model using federating learning with gradient boosted trees. The computer-implemented method includes training a global machine learning model using federated learning between a plurality of parties. The computer-implemented method also includes distributing the global machine learning model to each of the parties and receiving personalized model updates from each of the parties. The personalized model updates are generated from updated models boosted locally and produced by each of the parties using their respective local data. The computer-implemented method further includes fusing the personalized model updates to produce a boosted decision tree to update the global machine learning model. The computer-implemented method also includes iteratively training the global machine learning model in this manner until a stopping criterion is achieved.

Additional embodiments of the present disclosure include a computer program product of personalized training of a machine learning model using federated learning with gradient boosted trees, which can include a computer-readable storage medium having program instructions embodied therewith, the program instruction executable by a processor to cause the processor to perform a method. The method includes training a global machine learning model using federated learning between a plurality of parties. The method also includes distributing the global machine learning model to each of the parties and receiving personalized model updates from each of the parties. The personalized model updates are generated from updated models boosted locally and produced by each of the parties using their respective local data. The method further includes fusing the personalized model updates to produce a boosted decision tree to update the global machine learning model. The method also includes iteratively training the global machine learning model in this manner until a stopping criterion is achieved.

Further embodiments are directed to a system for personalized federated learning of a machine learning model with gradient boosted trees and configured to perform the methods described above. The present summary is not intended to illustrate each aspect of, every implementation of, and/or every embodiment of the present disclosure.

### BRIEF DESCRIPTION OF THE DRAWINGS

These and other features, aspects, and advantages of the embodiments of the disclosure will become better understood with regard to the following description, appended claims, and accompanying drawings where:

FIG. 1 is a block diagram illustrating a federated learning environment, in accordance with embodiments of the present disclosure.

FIG. 2 is a flow diagram illustrating a federated learning process, in accordance with embodiments of the present disclosure.

FIG. 3 is a flow diagram illustrating a federated learning process, in accordance with embodiments of the present disclosure.

FIG. 4 is a high-level block diagram illustrating an example computer system that may be used in implementing one or more of the methods, tools, and modules, and any related functions, described herein, in accordance with embodiments of the present disclosure.

FIG. 5 depicts a cloud computing environment, in accordance with embodiments of the present disclosure.

FIG. 6 depicts abstraction model layers, in accordance with embodiments of the present disclosure.

While the present disclosure is amenable to various modifications and alternative forms, specifics thereof have been shown by way of example, in the drawings and will be described in detail. It should be understood, however, that the intention is not to limit the particular embodiments described. On the contrary, the intention is to cover all modifications, equivalents, and alternatives falling within the scope of the present disclosure. Like reference numerals are used to designate like parts in the accompanying drawings.

### DETAILED DESCRIPTION

The present disclosure relates to federated learning and, more specifically, using federated learning techniques to train personalized machine learning models with gradient boosted trees. While the present disclosure is not necessarily limited to such applications, various aspects of the disclosure may be appreciated through a discussion of various examples using this context.

Generally, a large amount of data is required to empower artificial intelligence (AI) applications effectively. However, in many application domains, it can be challenging to obtain the amount of data necessary for these applications. Frequently, individuals or corporations only have a small amount of data where either the data is too small or it lacks essential information, such as missing values or labels.

Traditionally, data generated and owned by different parties and organizations would be collected and transferred to a centralized location to allow machine learning models to be built and trained using the collected data. However, data ownership concerns may arise during an attempt to acquire data. For example, a product recommendation service owner may claim ownership of the data regarding the products and purchase transactions but may lack ownership over the data regarding user purchasing behavior.

Additionally, recently enacted laws make collecting and sharing data among different organizations increasingly difficult, if not outright prohibited. Also, the sensitive nature of specific data (e.g., financial information, medical records) restricts the free circulation of that data. Thus, the sensitive data is typically isolated and maintained by the data owners.

Federated learning resolves the problem of data fragmentation and isolation while also complying with privacy-related laws. Federated learning aims to build a joint machine learning model based on data located across multiple sites. Two or more parties are interested in jointly building a machine learning model that holds data that can contribute to the model. During the training process, the data is held by each party and does not leave the party. The model can then be transferred in part from one party to another under an encryption scheme, such that other parties cannot re-engineer the data at any given party. The resulting model is approximate to an ideal model with all data transferred to a single party.

Gradient tree boosting, also known as gradient boosting machine or gradient boosted regression tree, is a widely used machine learning method that is typically used with decision trees of a fixed size as base learners. Typical gradient boosting algorithms begin by training a decision tree in which each observation is assigned an equal weight. After evaluating the first tree, observations that are difficult to classify are given more weight, while observations that are easy to classify are given less weight. A second tree is generated based on this weighted data.

XGBoost improves upon standard gradient tree boosting techniques using a tree learning algorithm. It is an end-to-end system that includes a sparsity-aware algorithm, a weighted quantile sketch procedure enabling the handling of instance weights in approximate tree learning, and a cache-aware block structure for out-of-core tree learning.

Limitations on federated learning a machine learning model using XGBoost exist, however, as training a single common model may not be sufficient for all parties involved in the federated learning process. Federated learning only develops a common output for all the users, and, therefore, it does not adapt the model to each user. For example, the parties may reside in separate states that require their model to provide predictions based on their respective locality. The answer provided by the model can depend highly on the geographical context of the party and may differ from place to place. Personalizing a model to a specific party's data distribution can be difficult without compromising the global model's overall performance. For instance, in settings where the underlying data distribution of users is not identical, the resulted global model, obtained from minimizing the average loss, may perform arbitrarily poorly once applied to the local dataset of each user. Additionally, the concept of personalization in XGBoost is difficult as the model structure that is appended together is based on tree structures instead of parameters like in neural networks.

Embodiments of the present disclosure may overcome the above and other problems, by implementing a system and a method for training personalized gradient decision boosted trees for federated learning. The system and method can interleave global parameters and local model parameters when computing gradients during the training of the model for optimal personalization of each participant.

More specifically, an aggregator trains a machine learning model using XGBoost with federated learning. During the training process, the aggregator iteratively collects each party's gradient descent and hessian statistics and aggregates the histograms of the participating parties to grow a tree structure of the model. Once trained, the aggregator can transmit the global model parameters back to the local parties. Each individual party can perform boosting based on their local data distribution that produces a new model personalized to that party. The new models from each of the parties can compute sets of gradients and hessian statistics that can be sent back to the aggregator to be used to computer new boosted trees for the global model. Thus, the model produced contains personalization from each participating party during each training iteration. The process continues iterations in this manner until a stopping criterion is met.

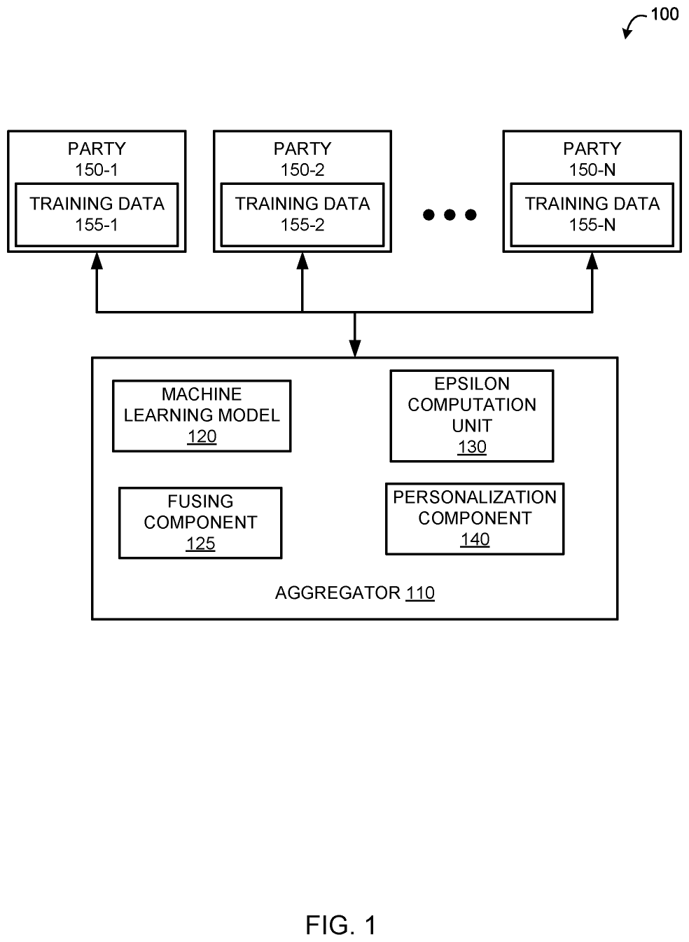

Referring now to FIG. 1, shown is a high-level block diagram of a federated learning environment 100 for personalized training a machine learning model using gradient boosted trees such as XGBoost. The federated learning environment 100 includes an aggregator 110, party 150-1, 150-2, 150-N (collectively “parties 150”), where N is a variable integer representing any number of possible parties 150. The tree boosting aggregator 110 includes a machine learning model 120, a fusing component 125, an epsilon computation unit 130, and a personalization component 140. The parties 150 include training datasets 155-1, 155-2, 155-N (collectively “training datasets 155”), respectively, where N is a variable integer representing any number of training datasets 155 corresponding to any number of parties 150.

The aggregator 110 is a component of the federated learning environment 100 configured to train the machine learning model 120 using the XGBoost algorithm and added personalization per training round. The aggregator 110 can initialize a connection with the parties 150 to initiate a training cycle for the machine learning model 120. Additionally, the aggregator 110 can query each party 150 requesting the number of samples in each of their training datasets 155 that can then be provided to the epsilon computation unit 130.

The aggregator 110 can build the machine learning model 120 using the XGBoost algorithm to recursively build upon a base learner decision tree. After each training iteration of the machine learning model 120, global-then-local personalization can be added to the decision tree where the previous tree had the largest errors or residuals. The boosted decision tree can be grown recursively, using information from the previous decision tree iteration to improve performance.

In some embodiments, the aggregator 110 utilizes a Model-Agnostic Meta-Learning (MAML) framework. Given a set of tasks drawn from an underlying distribution, in MAML, in contrast to traditional supervised learning settings, the goal is not to find a model which performs well on all tasks to a certain expectation. Instead, in MAML, it is assumed that there is a limited computational budget to update the model after a new task arrives. Using this basis, MAML looks for an initial model (Meta-model) which performs well after it is updated, with respect to the new tasks, possibly by one or a few steps of gradient descent. The parties 150 can take the machine learning model 120 and update it by going over their own data and performing just one or a few steps of gradient descent to obtain a model that works well for their own dataset.

The aggregator 110 is further configured to transmit the machine learning model 120 and a party-centric epsilon hyperparameter to each of the parties 150, respectively. The parties 150 can then train their respective machine learning model 120 using their respective training datasets 155. The aggregator 110 is further configured to receive model updates, including computed gradients, hessian statistics, and histograms from each of the parties 150. For example, party 150-1 can train the machine learning model 120 transmitted to it by the aggregator 110 using the training dataset 155-1. Upon completion of the training cycle, the party 150-1 can compute the gradient, hessian statistics, and histogram relating to the trained machine learning model 120 and training dataset 155-1 and transmit that information back to the aggregator 110.

Utilizing the gradients, hessian statistics, and histograms transmitted by the parties 150, the aggregator 110 can utilize XGBoost to conduct an additive training method in an iterative manner. The XGBoost performs a federated quantile sketch method to fuse the histograms received from each party 150, resulting in a global histogram. The global histogram is a surrogate representation of all of the training data without the raw values of the training data. The aggregator 110 can determine the optimal split candidates using the global histogram and grow the decision tree of the machine learning model 120. The aggregator 110 can continue this training process until a global termination or stopping criterion is achieved, resulting in a global machine learning model 120 (e.g., a global null model).

The aggregator 110 is further configured to transmit the current machine learning model 120 back to each respective party 150. The parties 150 can perform boosting individually based on their own local data distribution as well as the current global model provided by the aggregator 110. The parties 150 can individually compute local gradients from their own data distribution. The results of the local gradient produce a local machine learning model. Using the local machine learning model, the parties 150 can each compute sets of gradients and hessian statistics, which can be sent back to the aggregator 110. Using the gradients and hessian statistics provided by each party 150, the aggregator 110 can compute new boosted trees for the machine learning model 120 provided to the parties 150 to produce an updated machine learning model 120.

The training process can be iteratively repeated by retraining the updated machine learning model 120 by transmitting the updated machine learning model 120 to the parties with the model updates until a predetermined stopping criterion is achieved.

In some embodiments, the aggregator 110 trains the machine learning model 120 using a MAML-style personalization technique as displayed by Equation 1 shown below:

$${θ}_{G} ← arg {min}_{θ} {\sum }_{∈ p [ P ]} {ℓ}_{p} ( {θ}_{p} ( θ ) ) where \qquad Equation 1$$

$${θ}_{p} ( θ ) := θ - {α}_{p} {∇}_{θ} {ℓ}_{p} ( θ )$$

where θ_{G} represents the general model parameters of the global model 120, θₚ representing the per-party general model parameters of the model 120, P representing the number of parties 150, p representing a party index, [symbol] ₚ representing a loss per party, :=θ−αₚ∇_{θ} [symbol] ₚ(θ) representing the gradient descent process for updating the model parameter θ, where αₚ is the learning rate with respect to party p, and ∇_{θ} [symbol] ₚ(θ) is the gradient computed with respect to the loss function of party p with respect to party p's model parameter θ. Considering model parameters θ_{G} and θₚ, p∈[P] can be learned/personalized using gradient descent on a per-party loss [symbol] ₚ, p∈[P]. The personalization can be extended to k gradient descent steps instead of a single gradient descent step.

In some embodiments, the parties 150 accomplish the gradient descent steps using the following Equations [2-5] shown below:

$${θ}_{G}^{( t + 1 )} ← {θ}_{G}^{( t )} - β {\sum }_{p ∈ [ P ]} {∇}_{θ} {ℓ}_{p} ( {θ}_{G}^{( t )} - {α}_{p} {∇}_{θ} {ℓ}_{p} ( θ ) {\vert}_{θ = {θ}_{G}^{( t )}} ) \qquad Equation 2$$

where the following process performs gradient boosting at the t+1th iteration for the global model, as defined by θ_{G}^{(t+1)}, by updating the t-th model parameters through βΣ_{p∈[P]}∇_{θ} [symbol] ₚ(θ_{G}^{(t)}−αₚ∇_{θ} [symbol] ₚ(θ)|_{θ=θ}_{_{G}}_{^{(t)}}), which represents the sum of the gradients for each party P, with β representing the global learning rate. The above formulation can then also be further derived as follows:

$$= {θ}_{G}^{( t )} - β {\sum }_{p ∈ [ P ]} {∇}_{θ} {ℓ}_{p} ( θ ) {\vert}_{θ = {θ}_{G}^{( t )} - {α}_{p} {∇}_{θ} {ℓ}_{p} ( θ ) {\vert}_{θ = {θ}_{G}^{( t )}}} \cdot ( I - {∇}_{θ}^{2} {ℓ}_{p} ( θ ) {\vert}_{θ = {θ}_{G}^{( t )}} ) \qquad Equation 3$$

where θ_{G}^{(t)}−αₚ∇_{θ} [symbol] ₚ(θ)|_{θ=θ}_{_{G}}_{^{(t)}} represents the personalization θₚ^{(t)} and ∇_{θ}² [symbol] ₚ(θ)|_{θ=θ}_{_{G}}_{^{(t)}} represents a second-order term.

$$= {θ}_{G}^{( t )} - β {\sum }_{p ∈ [ P ]} {∇}_{θ} {ℓ}_{p} ( θ ) {\vert}_{θ = {θ}_{p}^{( t )}} \cdot ( I - {∇}_{θ}^{2} {ℓ}_{p} ( θ ) {\vert}_{θ = {θ}_{G}^{( t )}} ) \qquad Equation 4$$

where ∇_{θ}² [symbol] ₚ(θ)|_{θ=θ}_{_{G}}_{^{(t)}} can be ignored for FO-MAML. The result being:

$${θ}_{G}^{( t )} - β {\sum }_{p ∈ [ P ]} {∇}_{θ} {ℓ}_{p} ( θ ) {\vert}_{θ = {θ}_{p}^{( t )}} \qquad Equation 6$$

In some embodiments, the global tree of the machine learning model 120 mimics the trees obtained from the local boosting rounds by fitting the data for each (x, y)∈Dₚ for each party p∈[P]³ such that:

(x, fₚ¹(x)) Equation 10

The machine learning model 120 is a component of the tree boosting aggregator 110 configured as a predictive model using decision tree learning. The machine learning model 120 can use a decision tree as a predictive model to go from observations about an item, represented as branches, to conclusions about the item, represented as leaves. Tree models, where the target variable can take a discrete set of values, are called classification trees. In classification trees, the leaves represent class labels, and branches represent conjunctions of features that lead to those class labels. Decision trees where the target variable can take continuous values (e.g., real numbers) are called regression trees.

During training, the machine learning model 120 can be trained using the XGBoost framework to incrementally build upon the decision tree. At each training cycle, XGBoost can emphasize the training instances previously mis-modeled. The leaves that contained errors can then be split to grow the decision tree to allow for higher accuracy in the machine learning model's 120 predictions.

The fusing component 125 is a component of the tree boosting aggregator 110 configured to fuse histograms generated and provided by the parties 150 into a global histogram. In some embodiments, the fusing component 125 generates a surrogate dataset of the training datasets 155. The fusing component 125 can utilize the histogram, an ordered list of feature values, and a bin index from each of the parties 150 to extrapolate the surrogate dataset of the training datasets 155. The ordered list of feature values can define the threshold for each bin per histogram range, and the bin index is an index of values corresponding to which particular bin samples fall under. The list of feature values and the bin index can be provided in the model updates transmitted to the tree boosting aggregator 110 by the parties 150.

In some embodiments, the fusing component 125 computes an optimal bin resolution based on a learning task performed by the machine learning model 120. For example, if the learning task is based on classification, then the fusing component 125 finds the largest bin resolution. If the learning task is based on regression, then the fusing component 125 finds the smallest bin resolution. The fusing component 125 can then construct the global histogram using the surrogate dataset and the new bin size based on the learning task. This can be accomplished by finding new thresholds and computing a new index value per sample.

In some embodiments, the fusing component 125 fuses the histograms into the global histogram by merging bins nearest to each other and replacing them with a single bin. The merging can continue until the global histogram meets a predefined maximum bin size.

The epsilon computation component 130 is a component of the tree boosting aggregator 110 configured to compute individualized epsilon hyperparameters for each of the parties 150. The epsilon hyperparameter can be used as a bin size indicator for each party 150, which can dictate the accuracy of the histogram approximation. In some embodiments, the epsilon computation component 130 computes the epsilon hyperparameter as a sample ratio-based distribution. The epsilon computer component 130 can compute the epsilon as a sample ratio-based distribution using equation 11 defined below:

$${ϵ}_{i} = ϵ ( \frac{\vert {d}_{i} \vert}{{\sum }_{d ∈ D} \vert d \vert} ) \qquad Equation 11$$

where ϵ represents the epsilon hyperparameter defined as a global measure of how much to approximate the surrogate dataset of the training dataset 155 from each of the parties 150. The training dataset 155 from each of the parties 150 can be defined as D={d₁, d₂, . . . , dₙ}. The ϵᵢ can represent the epsilon hyperparameter score for each i^{th} worker. The ϵ parameter can be split with the ratio of the i^{th} party's training dataset 155 size to the total amount of data amongst the parties 150. Thus, each party 150 can contribute a surrogate representation of the dataset with the optimal number of the histogram bins as defined by

$$\frac{1}{ϵ} ,$$

which can be defined by equation 12, defined below:

$$\frac{1}{{ϵ}_{i}} = \frac{1}{ϵ ( \frac{\vert {d}_{i} \vert}{{\sum }_{d ∈ D} \vert d \vert} )} = \frac{{\sum }_{d ∈ D} \vert d \vert}{ϵ \vert {d}_{i} \vert} \qquad Equation 12$$

The personalization component 140 is a component of the aggregator 110 configured to aggregate personalized model updates used by the machine learning model 120. The personalization component 140 is configured to aggregate personalized model updates from the participating parties 150. The participating parties 150 can generate the personalized model updates from updated models boosted locally and produced by the parties 150.

The parties 150 are the participants in the federated learning environment 100 performing localized training of the machine learning model 120 using their respective training dataset 155. Using the machine learning model 120, the parties 150 can compute predictions using their respective training dataset 155. Additionally, the parties 150 can compute the gradient and hessian statistics of the computed predictions.

In some embodiments, the parties 150 boost the machine learning model 120 with gradient descent boosting. With gradient descent boosting, at (t+1)^{th} with t representing the tree of the machine learning model 120, the (t+1)^{th} is trained to fit

$$( x , \frac{\partial ℓ ( y , F )}{\partial F} {\vert}_{F = {F}^{t} ( x )} )$$

where (x, y)∈D. The x represents the features or covariates, y represents the target for the model 120 to achieve, F represents the model 120, with F^{t}(x) representing the model at the end of the t^{th} round.

Based on the above personalization with a single local boosting round per party 150, the following Equation 7 can represent the target:

$$\frac{\partial ℓ ( y , F + {f}_{p}^{1} ( x ) )}{\partial F} {\vert}_{F = {F}_{G}^{t} ( x )} = \frac{\partial ℓ ( y , F )}{\partial F} {\vert}_{F = {F}_{G}^{t} ( x ) + {f}_{P}^{1} ( x )} \cdot ( 1 + \frac{\partial {f}_{p}^{1} ( x )}{\partial F} {\vert}_{F = {F}_{G}^{t} ( x )} ) \qquad Equation 7$$

If the second-order term

$$\frac{\partial {f}_{p}^{1} ( x )}{\partial F} {\vert}_{F = {F}_{G}^{t} ( x )}$$

is ignored, the following result is demonstrated by Equation 8 below:

$$\frac{\partial ℓ ( y , F + {f}_{p}^{1} ( x ) )}{\partial F} {\vert}_{F = {F}_{G}^{t} ( x )} = \frac{\partial ℓ ( y , F )}{\partial F} {\vert}_{F = {F}_{G}^{t} ( x ) + {f}_{p}^{1} ( x )} \qquad Equation 8$$

As such, the (t+1)^{th} the global tree can try to fit the following data demonstrated by Equation 9 for each (x,y)∈Dₚf for each p∈[P] such that:

$$( x , \frac{\partial ℓ ( y , F )}{\partial F} {\vert}_{F = {F}_{G}^{t} ( x ) + {f}_{p}^{1} ( x )} ) \qquad Equation 9$$

In some embodiments, the parties 150 also exploit the epsilon hyperparameter using a quantile sketch process to generate histograms reflecting their respective training datasets 155. The epsilon hyperparameter can be used as a bin size when generating the histogram. Histograms can be used to summarize label and feature values of the training dataset 155. A histogram can be built over the training dataset 155 in a single pass. For each sample in the training dataset 155, a new bin is added to the histogram. Binning is a method of turning continuous variables (e.g., labels and features) into categorical values. The values can be grouped into a predefined number of bins determined by the epsilon hyperparameter. The continuous values can then get replaced by a string describing the bin that contains the value, thereby anonymizing the information contained in the continuous variables.

It is noted that FIG. 1 is intended to depict the major representative components of an exemplary federated learning environment 100. In some embodiments, however, individual components may have greater or less complexity than as represented in FIG. 1, components other than or in addition to those shown in FIG. 1 may be present, and the number, type, and configuration of such components may vary.

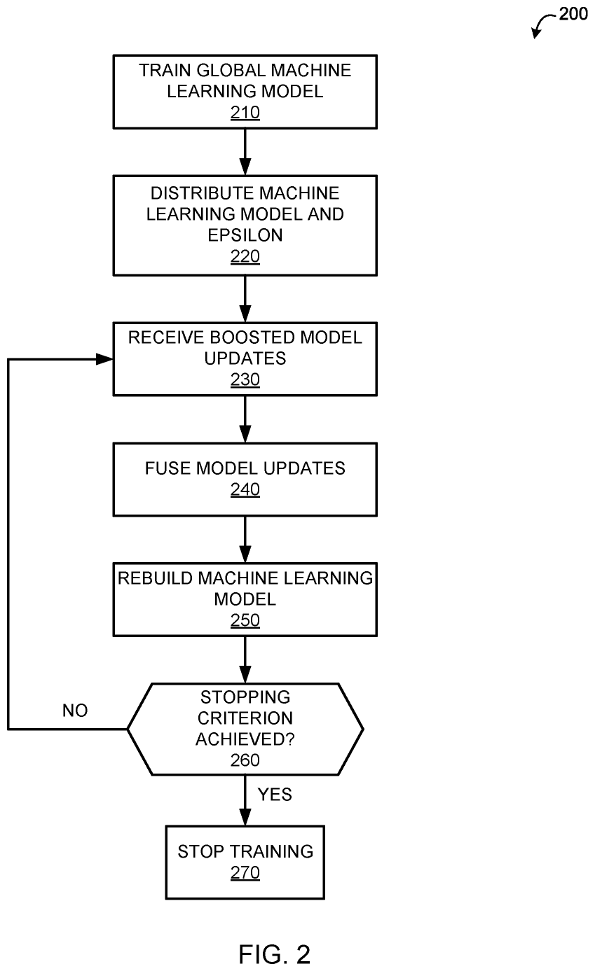

FIG. 2 is a flow diagram illustrating a process 200 of personalized federated learning of a machine learning model using the gradient boosted trees such as the XGBoost framework, in accordance with embodiments of the present disclosure. The process 200 can be implemented by, for example, one or more entities in a federated learning environment 100, a computer system 400, a processor, or another configuration of hardware and/or software.

The aggregator 110 trains a base machine learning model 120 using model parameters provided by the parties 150. This is illustrated at step 210 The aggregator 110 can transmit the base machine learning model 120 with party-centric epsilon parameters to each of the parties 150. Using the epsilon parameters, each party can compute predictions using their respective machine learning model 120 using their training dataset 155 and epsilon hyperparameter. The parties 150 can then compute model updates, such as gradients, index thresholds, bin indexes, and hessian statistics from those predictions, as well as histograms representing their training datasets 155. Once computed, each party 150 can transmit the model updates and histograms back to the aggregator 110 to train the machine learning model 120 using the model updates.

The aggregator 110 transmits the updated machine learning model 120 and the epsilon hyperparameter to the parties 150. This is illustrated at step 220. Once transmitted, each party can boost the machine learning model 120 using the XGBoost algorithm to recursively build upon the decision tree of the machine learning model 120. After each training iteration of the machine learning model 120, a split candidate can be added to the decision tree where the previous tree had the largest errors or residuals. The boosted decision tree can be grown recursively, using information from the previous decision tree iteration to improve performance. Once boosted, the parties 150 can each compute predictions using their respective machine learning model 120 using their training dataset 155 and epsilon hyperparameter. The parties 150 can then compute personalized model updates, such as gradients, index thresholds, bin indexes, and hessian statistics from those predictions, as well as histograms representing their training datasets 155 based on their data distribution. Once computed, each party 150 can transmit the personalized model updates and histograms back to the aggregator 110 for further computation.

The aggregator 110 receives the personalized model updates from each of the parties 150. This is illustrated at step 230. Using the personalized model updates, the fusing component 125 fuses the histograms of the parties 150 into a global histogram. This is illustrated at step 240. The global histogram can reflect an anonymized representation of the entire training dataset 155 used by all of the parties 150, including personalization introduced via the boosting performed by each party 150.

The aggregator 110 can rebuild the machine learning model 120 from the global histogram computed from the personalized model updates. This is illustrated at step 250. The decision tree of the machine learning model 120 can be viewed as an initial fixed function. The rebuilt machine learning model 120 can be analyzed to determine whether a stop criterion has been achieved. This is illustrated at step 260. The rebuilt machine learning model and the epsilon hyperparameters can be transmitted to the parties 150, where the parties 150 can train and test the machine learning model 120. If the machine learning model 120 has not reached a stopping criterion, the process 300 can return to step 330 and repeat the steps in an iterative manner until the stopping criterion is achieved. However, if the stopping criterion is achieved, the process 200 is complete, and the training process stops. This is illustrated at step 270.

In some embodiments, the stopping criterion is the number of iterations the process 200 performs. In some embodiments, the stopping criterion is a measurement of accuracy the machine learning model 120 must achieve in its predictions prior to stopping. In some embodiments, the stopping criterion is a depth of the decision tree used by the machine learning model 120.

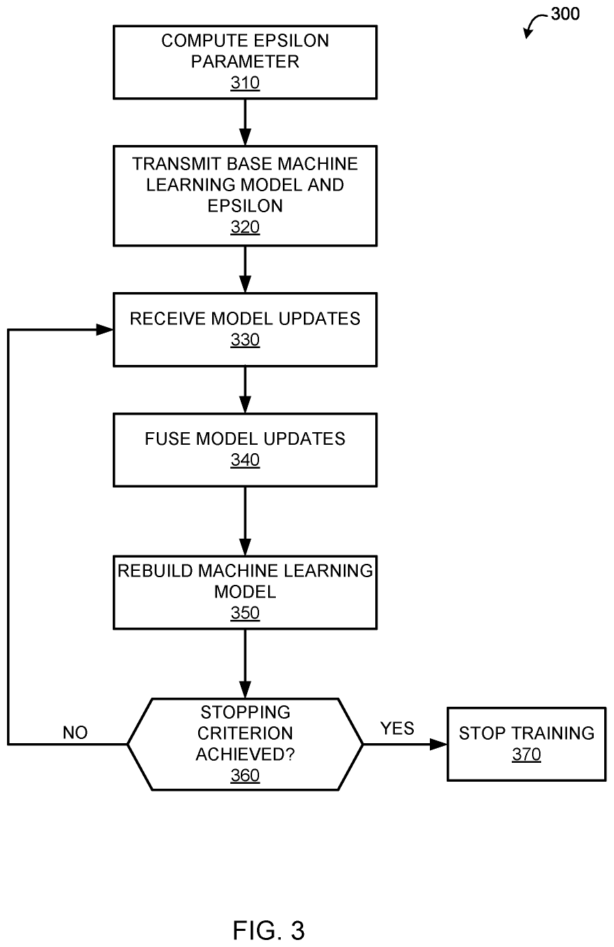

FIG. 3 is a flow diagram illustrating a process 300 of initial federated learning of a machine learning model using the XGBoost framework, in accordance with embodiments of the present disclosure. The process 300 can be implemented by, for example, one or more entities in a federated learning environment 100, a computer system 400, a processor, or another configuration of hardware and/or software.

The aggregator 110 can query each party 150 for the number of samples in their respective training dataset 155. Based on the number of samples in each training dataset 155, the aggregator 110 can compute a ratio of those samples per party. This is illustrated at step 310. The epsilon computation component 130 can utilize a baseline global epsilon hyperparameter with the sample ratio per party to compute and transmit an individualized epsilon hyperparameter to each party 150 participating in the learning process.

The aggregator 110 transmits the machine learning model 120 and the epsilon hyperparameter to the parties 150. This is illustrated at step 320. Once transmitted, each party can compute predictions using their respective machine learning model 120 using their training dataset 155 and epsilon hyperparameter. The parties 150 can then compute model updates, such as gradients, index thresholds, bin indexes, and hessian statistics from those predictions as well as histograms representing their training datasets 155. Once computed, each party 150 can transmit the model updates and histograms back to the aggregator 110 for further computation.

The aggregator 110 receives the model updates from each of the parties 150. This is illustrated at step 330. Using the model updates, the fusing component 125 fuses the histograms of the parties 150 into a global histogram. This is illustrated at step 340. The global histogram can reflect an anonymized representation of the entire training dataset 155 used by all of the parties 150. The fusing component 125 can construct a surrogate index and compute a bin size for each of the histograms received. Once determined, the fusing component 125 can generate the global histogram from the computed bin sizes and histograms.

In some embodiments, the epsilon computation component 130 recomputes the epsilon hyperparameters for each of the parties 150 based on the global histogram and samples per party. For example, the global histogram may reflect that the first party 150 requires a larger bin size while the second party 150 requires a smaller bin size. The epsilon hyperparameters can be adjusted accordingly.

The aggregator 110 can rebuild the machine learning model 120 from the global histogram computed from the model updates. This is illustrated at step 350. The decision tree of the machine learning model 120 can be viewed as an initial fixed function. The rebuilt machine learning model 120 can be analyzed to determine whether a stop criterion has been achieved. This is illustrated at step 360. The rebuilt machine learning model and the epsilon hyperparameters can be transmitted to the parties 150, where the parties 150 can train and test the machine learning model 120. If the machine learning model 120 has not reached a stopping criterion, the process 300 can return to step 330 and repeat the steps in an iterative manner until the stopping criterion is achieved. However, if the stopping criterion is achieved, the process 300 is complete, and the training process stops. This is illustrated at step 370.

In some embodiments, the stopping criterion is a number of iterations the process 300 performs. In some embodiments, the stopping criterion is a measurement of accuracy the machine learning model 120 must achieve in its predictions prior to stopping. In some embodiments, the stopping criterion is a depth of the decision tree used by the machine learning model 120.

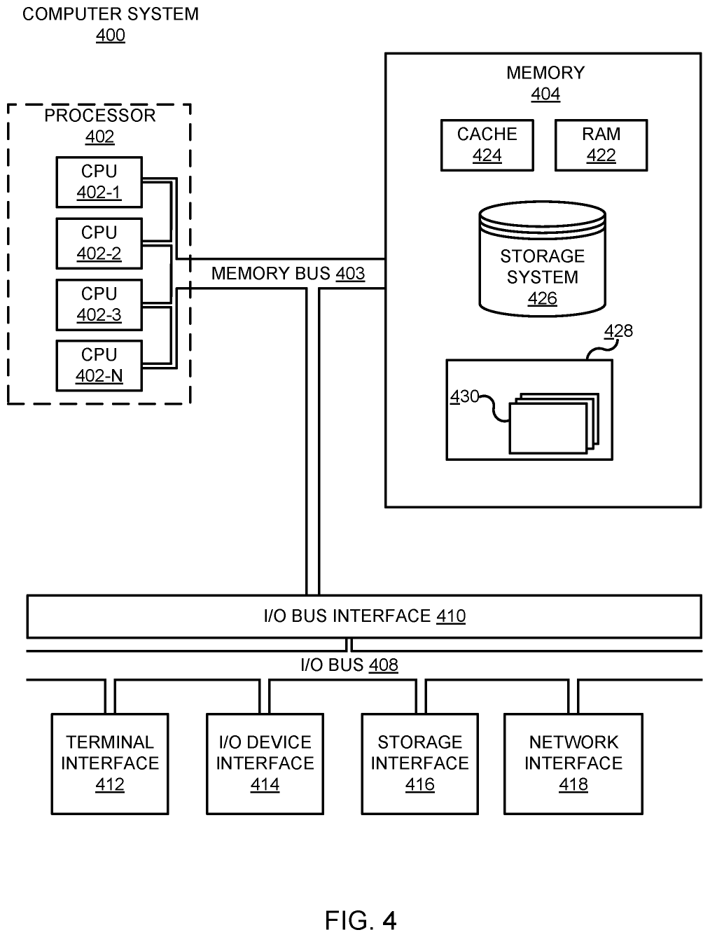

Referring now to FIG. 4, shown is a high-level block diagram of an example computer system 400 (e.g., the federated learning environment 100) that may be used in implementing one or more of the methods, tools, and modules, and any related functions, described herein (e.g., using one or more processor circuits or computer processors of the computer), in accordance with embodiments of the present disclosure. In some embodiments, the major components of the computer system 400 may comprise one or more processors 402, a memory 404, a terminal interface 412, an I/O (Input/Output) device interface 414, a storage interface 416, and a network interface 418, all of which may be communicatively coupled, directly or indirectly, for inter-component communication via a memory bus 403, an I/O bus 408, and an I/O bus interface 410.

The computer system 400 may contain one or more general-purpose programmable central processing units (CPUs) 402-1, 402-2, 402-3, and 402-N, herein generically referred to as the processor 402. In some embodiments, the computer system 400 may contain multiple processors typical of a relatively large system; however, in other embodiments, the computer system 400 may alternatively be a single CPU system. Each processor 401 may execute instructions stored in the memory 404 and may include one or more levels of on-board cache.

The memory 404 may include computer system readable media in the form of volatile memory, such as random-access memory (RAM) 422 or cache memory 424. Computer system 400 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”) or an optical disk drive for reading from or writing to a removable, non-volatile optical disc such as a CD-ROM, DVD-ROM or other optical media can be provided. In addition, the memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

Although the memory bus 403 is shown in FIG. 4 as a single bus structure providing a direct communication path among the processors 402, the memory 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 400 may, in some embodiments, contain multiple I/O bus interface units, multiple I/O buses, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 400 may be a multi-user mainframe computer system, a single-user system, or a server computer or similar device that has little or no direct user interface but receives requests from other computer systems (clients). Further, in some embodiments, the computer system 400 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the major representative components of an exemplary computer system 400. In some embodiments, however, individual components may have greater or lesser complexity than as represented in FIG. 4, components other than or in addition to those shown in FIG. 4 may be present, and the number, type, and configuration of such components may vary.

One or more programs/utilities 428, each having at least one set of program modules 430 (e.g., the federated learning environment 100), may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

It is to be understood that although this disclosure includes a detailed description on cloud computing, implementation of the teachings recited herein is not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and P.D.A.s).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

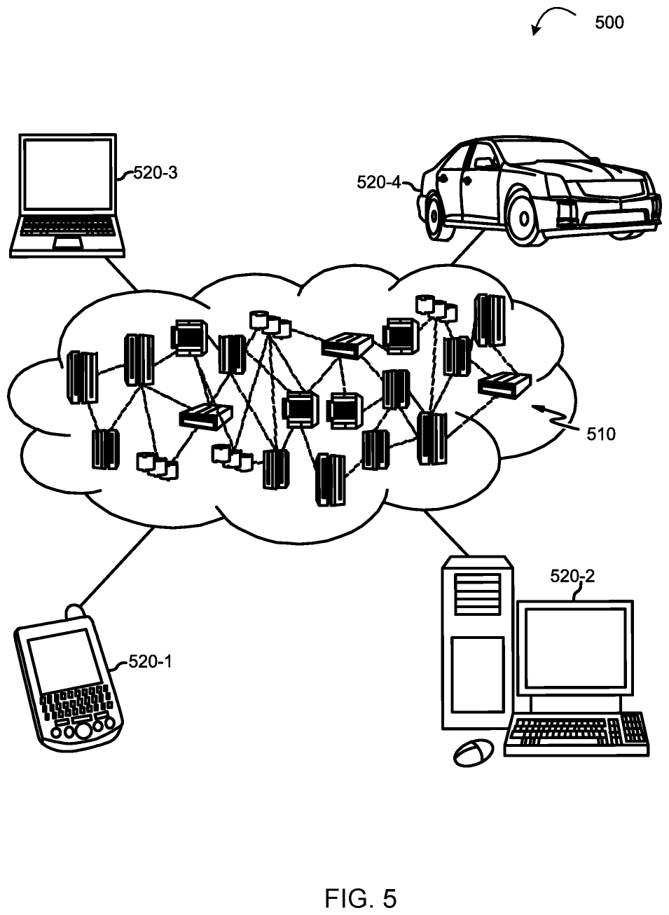

Referring now to FIG. 5, illustrative cloud computing environment 500 is depicted. As shown, cloud computing environment 500 includes one or more cloud computing nodes 510 with which local computing devices used by cloud consumers, such as, for example, personal digital assistant (P.D.A.) or cellular telephone 520-1, desktop computer 520-2, laptop computer 520-3, and/or automobile computer system 520-4 may communicate. Nodes 510 may communicate with one another. They may be grouped (not shown) physically or virtually, in one or more networks, such as Private, Community, Public, or Hybrid clouds as described hereinabove, or a combination thereof. This allows cloud computing environment 500 to offer infrastructure, platforms and/or software as services for which a cloud consumer does not need to maintain resources on a local computing device. It is understood that the types of computing devices 520-1 to 520-4 shown in FIG. 5 are intended to be illustrative only and that computing nodes 510 and cloud computing environment 500 can communicate with any type of computerized device over any type of network and/or network addressable connection (e.g., using a web browser).

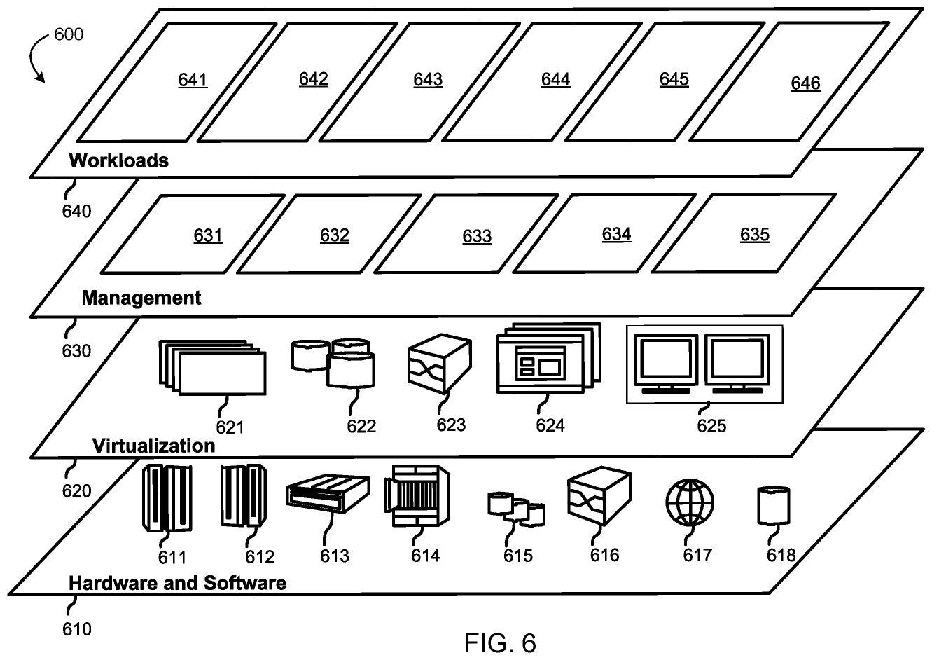

Referring now to FIG. 6, a set of functional abstraction layers 600 provided by cloud computing environment 500 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 610 includes hardware and software components. Examples of hardware components include mainframes 611; RISC (Reduced Instruction Set Computer) architecture-based servers 612; servers 613; blade servers 614; storage devices 615; and networks and networking components 616. In some embodiments, software components include network application server software 617 and database software 618.

Virtualization layer 620 provides an abstraction layer from which the following examples of virtual entities may be provided: virtual servers 621; virtual storage 622; virtual networks 623, including virtual private networks; virtual applications and operating systems 624; and virtual clients 625.

In one example, management layer 630 may provide the functions described below. Resource provisioning 631 provides dynamic procurement of computing resources and other resources that are utilized to perform tasks within the cloud computing environment. Metering and Pricing 632 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 633 provides access to the cloud computing environment for consumers and system administrators. Service level management 634 provides cloud computing resource allocation and management such that required service levels are met. Service Level Agreement (S.L.A.) planning and fulfillment 635 provide pre-arrangement for, and procurement of, cloud computing resources for which a future requirement is anticipated in accordance with an S.L.A.

Workloads layer 640 provides examples of functionality for which the cloud computing environment may be utilized. Examples of workloads and functions which may be provided from this layer include mapping and navigation 641; software development and lifecycle management 1342 (e.g., the federated learning environment 100); virtual classroom education delivery 643; data analytics processing 644; transaction processing 645; and training a machine learning model using federated learning 646.

The present invention may be a system, a method, and/or a computer program product at any possible technical detail level of integration. The computer program product may include a computer-readable storage medium (or media) having computer readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (R.O.M.), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (I.S.A.) instructions, machine instructions, machine dependent instructions, microcode, firmware instructions, state- setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (P.L.A.) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But the various embodiments may be practiced without these specific details. In other instances, well-known circuits, structures, and techniques have not been shown in detail in order not to obscure embodiments.

When different reference numbers comprise a common number followed by differing letters (e.g., 100a, 100b, 100c) or punctuation followed by differing numbers (e.g., 100-1, 100-2, or 100.1, 100.2), use of the reference character only without the letter or following numbers (e.g., 100) may refer to the group of elements as a whole, any subset of the group, or an example specimen of the group.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure may not be necessary. The previous detailed description is, therefore, not to be taken in a limiting sense.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present invention has been described in terms of specific embodiments, it is anticipated that alterations and modification thereof will become apparent to the skilled in the art. Therefore, it is intended that the following claims be interpreted as covering all such alterations and modifications as fall within the true spirit and scope of the invention.

What is claimed is:

1. A computer-implemented method of training a personalized machine learning model using federated learning, the computer-implemented method comprising:
training a global machine learning model using federated learning between a plurality of parties;
distributing the current global machine learning model to each of the parties and the parties performing local boosting steps by computing gradients and hessian statistics relating to the global machine learning model and their private datasets;
receiving personalized model updates from each of the parties, wherein the personalized model updates are generated from updated models boosted locally and produced by each of the parties using their respective local data;
fusing the personalized model updates to produce a boosted decision tree to update the global machine learning model; and
rebuilding the global machine learning model using the boosted decision tree.

2. The computer-implemented method of claim 1, further comprising:
starting with the updated global machine learning model, retraining the global machine learning model in an iterative manner, with the global machine learning model from the personalized model updates acting as an initial model transmitted to the parties for a next iteration, until a predetermined stopping criterion is achieved.

3. The computer-implemented method of claim 1, wherein training the global machine learning model comprises:
establishing a connection between an aggregator and the plurality of parties;
computing, by the aggregator, party-centric epsilon parameters for each party of the plurality of parties based on a global epsilon parameter;
transmitting a party-centric epsilon parameter to each of the plurality of parties;
receiving, from the parties, histogram data distributions representing raw training data maintained by the parties;
generating a global machine learning model based on the histogram data distributions;
transmitting the global machine learning model to the parties;
receiving model updates from each of the parties, wherein each of the model updates includes a histogram, a gradient, and hessian statistics based on applying the global machine learning model to training data stored by the parties; and
fusing the model updates to produce a global histogram to update the global machine learning model.

4. The computer-implemented method of claim 3, further comprising:
starting with the updated global machine learning model, retraining the global machine learning model in an iterative manner, with the global machine learning model from the model updates acting as an initial model transmitted to the parties for a next iteration, until a predetermined stopping criterion is achieved.

5. The computer-implemented method of claim 3, wherein the party-centric epsilon parameter is specific to each party of the plurality of parties based on sizes of the training data provided by each party.

6. The computer-implemented method of claim 1, wherein the personalized model updates are produced using gradient descent on a per-party loss.

7. The computer-implemented method of claim 1, wherein model-agnostic meta-learning is used to train the machine learning model.

8. The computer-implemented method of claim 1, wherein the updated global machine learning model mimics trees obtained from local boosting by the parties using their local distribution to add personalization.

9. A computer program product comprising a computer readable storage medium having computer readable instructions stored therein, wherein the computer readable instructions for training a personalized machine learning model using federated learning, when executed on a computing device, causes the computing device to:
train a global machine learning model using federated learning between a plurality of parties;
distributing the current global machine learning model to each of the parties and the parties performing local boosting steps by computing gradients and hessian statistics relating to the global machine learning model and their private datasets;
receive personalized model updates from each of the parties, wherein the personalized model updates are generated from updated models boosted locally and produced by each of the parties using their respective local data;
fuse the personalized model updates to produce a boosted decision tree to update the global machine learning model; and
rebuild the global machine learning model using the boosted decision tree.

10. The computer program product of claim 9, further comprising computer readable instructions, stored on the computer readable storage medium, to:
starting with the updated global machine learning model, retrain the global machine learning model in an iterative manner, with the global machine learning model from the personalized model updates acting as an initial model transmitted to the parties for a next iteration, until a predetermined stopping criterion is achieved.

11. The computer program product of claim 9, wherein the computer readable instructions to train the global machine learning model comprise computer readable instructions, stored on the computer readable storage medium, to:
establish a connection between an aggregator and the plurality of parties;
compute, by the aggregator, party-centric epsilon parameters for each party of the plurality of parties based on a global epsilon parameter;
transmit a party-centric epsilon parameter to each of the plurality of parties;
receive, from the parties, histogram data distributions representing raw training data maintained by the parties;
generate a global machine learning model based on the histogram data distributions;
transmit the global machine learning model to the parties;
receive model updates from each of the parties, wherein each of the model updates includes a histogram, a gradient, and hessian statistics based on applying the global machine learning model to training data stored by the parties; and
fuse the model updates to produce a global histogram to update the global machine learning model.

12. The computer program product of claim 11, further comprising computer readable instructions, stored on the computer readable storage medium, to:
starting with the updated global machine learning model, retrain the global machine learning model in an iterative manner, with the global machine learning model from the model updates acting as an initial model transmitted to the parties for a next iteration, until a predetermined stopping criterion is achieved.

13. The computer program product of claim 11, wherein the party-centric epsilon parameter is specific to each party of the plurality of parties based on sizes of the training data provided by each party.

14. The computer program product of claim 9, wherein the personalized model updates are produced using gradient descent on a per-party loss.

15. The computer program product of claim 9, wherein model-agnostic meta-learning is used to train the machine learning model.

16. The computer program product of claim 9, wherein the updated global machine learning model mimics trees obtained from local boosting by the parties using their local distribution to add personalization.

17. A system for training a machine learning model using federated learning, the system comprising:
a memory;
a processor;
a storage having stored thereon computer executable program code;
a machine learning model configured as a predictive model using decision tree learning;
an aggregator configured to facilitate federated learning on the machine learning model, wherein the aggregator is further configured to transmit the machine learning model and individualized epsilon hyperparameters to a first party and a second party participating in the federated learning;
an epsilon computation component configured to compute the individualized epsilon hyperparameters for the first party and the second party, wherein the epsilon hyperparameter represents a bin size indicator;
a personalization component configured to aggregate model updates from the first party and the second party generated from updated models boosted locally and produced by the first party and the second party using their respective local data; and
a fusing component configured to fuse the model updates generated and provided by the first party and the second party into a global histogram to update the machine learning model during training.

18. The system of claim 17, wherein the model updates are produced using gradient descent on a per-party loss.

19. The system of claim 17, wherein model-agnostic meta-learning is used to train the machine learning model.

20. The system of claim 17, wherein the machine learning model mimics trees obtained from local boosting by the parties using their local distribution to add personalization during training.
